(19) United States
(12) Patent Application Publication
(10) Pub. No.: US 2002/0007920 A1
(43) Pub. Date: Jan. 24, 2002

(54) Methods for selecting a treatment

(76) Inventor: Carlene Lower, McKinney, TX (US)

Correspondence Address: Carolyn A. Favorito, Morrison & Foerster LLP, Suite 500, 3811 Valley Centre Drive, San Diego, CA, 92130-2332, US

(21) Appl. No.: 09/863,171

(22) Filed: May 22, 2001

Related U.S. Application Data
(62) Division of application No. 09/438,470, filed on Nov. 12, 1999.
(60) Provisional application No. 60/108,110, filed on Nov. 12, 1998.

(51) Int. Cl. E06B 9/00

(52) U.S. Cl. 160/38

(57) ABSTRACT

A system for creating custom-look window treatments using tabs and interchangeable modular shaped fabric units. The invention allows for multiple window top treatments configurations by arranging modular units horizontally on a rod or by attaching layered fabric units to each other and arranging them on the rod. Since the system is based upon individual modules, any window size can be accommodated using a single layer of modules or layering the modular fabric units.

### CROSS REFERENCE TO RELATED APPLICATIONS

This application claims priority from provisional application Ser. No. 60/108,110 filed Nov. 12, 1998, the contents of which are incorporated herein by reference.

### BACKGROUND OF THE INVENTION

1. Field of the Invention

This invention relates to a modular system for selecting window treatments from prefabricated components. More specifically, the invention is a system for selecting various interchangeable prefabricated modules that, when optionally combined with independent couplers, offer a wide array of custom-look treatments to fit any size window or area to be treated.

2. Description of the Prior Art

In the past, essentially two types of window treatments were available to consumers, namely ready made treatments or custom. Ready-made treatments were available in limited styles and fabrics, and were available in standard sizes. Installation of ready-made treatments, however, was generally simple and the prices were inexpensive. In contrast, custom window treatments offered extensive styles and wide range of fabrics and could be custom tailored to a particular window or area to be treated. However, such custom window treatments were difficult to install and expensive. In addition, it was often necessary to enlist the help of a professional to create custom window treatments. There is a lengthy process to order, create and install custom window treatments. Thus, there is a need to have a window treatment system that would combine the benefits of ready-made window treatments with the benefits of custom treatments, without the disadvantages of each.

The prior art valance systems do not anticipate or render obvious the present invention. Prior art valance assemblies such as U.S. Pat. No. 5,191,922 to Wade, U.S. Pat. No. 5,803,144 to Ives, U.S. Pat. No. 5,738,159 to O'Brien and U.S. Pat. No. 5,067,542 to Easley, lack interchangeability and also lack the module approach for creating window treatments.

U.S. Pat. No. 5,191,922 to Wade uses a full length curtain with a flap to loop over a rod to secure placement of the curtain. Snaps on the front face of the curtain allow valance attachments to snap onto the curtain. The valance attachment is not a modular based system. It also does not allow the valance to be mounted independently of the curtain.

U.S. Pat. No. 5,803,144 to Ives discloses an extruded PVC channel system designed to create a valance over blind or drapery systems to allow installation of decorative inserts therein. It does not disclose a module system that allows consumers to mix and match of variously shaped modules and couplers to create indefinite combinations. It is not interchangeable to conform to different window sizes.

U.S. Pat. No. 5,738,159 to O'Brien discloses a single interchangeable panel that is capable of being arranged in a variety of different ways to change a window drape appearance. The treatment allows for the drape to be hung by using rings, a rod pocket or tabs. There are strings fabricated into the drape to allow for the drape to be pulled into a balloon or austrian. The components of flexibility are all constructed into the drape and not independent to allow for modification of the drapery size and/or appearance with the interchanging and arrangement of modules of different styles and/or colors.

U.S. Pat. No. 590,141 to Easley discloses a system comprising parallel curtain rods for mounting a valance on one rod and a cascade on the other. This system is packaged as ready-made swag and jabot sets and is not a module-based system and thus does not provide a system to intermingle or layer different shaped modules to create multiple decorative styles.

### SUMMARY OF THE INVENTION

In order to overcome the problems described above and other problems inherent in the prior art, this invention provides a modular treatment system comprised of selecting a combination of interchangeable prefabricated finished components also referred to herein as modules from a plurality of modules of different shapes and or sizes and attaching the selected modules to a decorative rod with couplers that are also individually selected and interchanged. When combined in various ways, the modular fabric units of the system provide diverse treatment styles and color combinations, and for example, can form a custom-look window treatment. The invention is directed to any treatment area such as windows, showers or walls.

The invention also provides for a method of selecting modules and couplers using directions based on a selected width of an area to be treated to form a custom-look treatment. Such a selection can take place over a communications network. Further, the selection process can be performed using a computer program. In another embodiment, a kit is provided which has components that have been selected from the system, which includes directions to install the system.

All modules are prefabricated components that are provided independently, therefore, the end user chooses only the modules for a chosen design based upon a width for a particular window size. The prefabricated components distinguish from custom treatments in that custom treatments require the end user to select a fabric and style before the fabrication of the treatment, making it an expensive and time consuming project. The modular system allows the treatment to be re-used on a differently sized window area or other area to be treated by adding, removing, or interchanging modules.

It is one of the objects of this invention to provide a interchangeable modular window treatment system. Such a system provides modules that can be added or removed to change the look of the treatment. The end-user can add seasonal changes or decorative accessories to also change the look.

Another object of this invention to provide a plurality of styles of modules and couplers that are of various materials, colors, and/or shapes to provide infinite combinations of modules depending upon the selection of the end user.

Another object of this invention to provide to the end user with the benefits of the custom and ready made treatments fabrication of valance treatments, such as moderate pricing, simplicity of installation, extensive style and/or color and/or material options. By utilizing the styles and fabrics of the custom market and producing the product in a repetitive manufacturing process with a consistent module size, the process is streamlined to provide the consumer the choices of custom treatments with the favorable delivery and price of ready made treatments. The modules are finished, that is premade, components of a window treatment.

A still further object of the invention is to accommodate all expanse sizes. By utilizing a particular module size all expanses can be accommodated. The modular nature of the invention allows re-use of the product by adding or removing modules as necessary.

Unlike ready made window treatments that dictate the finished appearance by offering predetermined styles and sizes, the invention allows for the decision of the finished appearance of a window treatment to be determined at the time of purchase by combining and interchanging modular fabric pieces and colors.

### BRIEF DESCRIPTION OF THE DRAWINGS

FIG. 1 is a front view of the triangular module.

FIG. 2 is a front view of a large rectilinear module.

FIG. 3 is a front view of a scalloped module.

FIG. 4 is a front view of a small rectilinear module.

FIG. 5 is a flat view of the tab.

FIG. 6 is a view of the tab closed.

FIG. 7 is a front view of the jabot.

FIG. 8 is a front view of the cascade left.

FIG. 9 is a front view of the cascade right.

FIG. 10 is an elevation of a concept using the module units in combination of the tabs and the large rectilinear shape.

FIG. 11 is an elevation of a concept using the module units in combination of the tabs and the scalloped shape.

FIG. 12 is an elevation of a concept using the module units in combination of the tabs and the triangular shape.

FIG. 13 is an elevation of a concept using the module units in combination of the tabs and the scalloped shape.

FIG. 14 is an elevation of a concept using the module units in combination of the tabs and the triangular shape.

FIG. 15 is an elevation of a concept using the module units in combination of the tabs, the scallop, and the large rectilinear shape.

FIG. 16 is an elevation of a concept using the module units in combination of the tabs, the triangular, and the large rectilinear shape.

FIG. 17 is an elevation of a concept using the module units in combination of the tabs and the large rectilinear shape.

FIG. 18 is an elevation of a concept using the module units in combination of the tabs and the scalloped shape.

FIG. 19 is an elevation of a concept using the module units in combination of the tabs and the triangular shape.

FIG. 20 is an elevation of a concept using the module units in combination of the tabs, the large rectilinear shape and the small rectilinear shape.

FIG. 21 is an elevation of a concept using the module units in combination of the tabs, the triangular shape, and the jabot.

FIG. 22 is an elevation of a concept using the module units in combination of the tabs, the large rectilinear shape, and the jabot.

FIG. 23 is an elevation of a concept using the module units in combination of the tabs, the scalloped shape, and the jabot.

FIG. 24 is an elevation of a concept using the module units in combination of the tabs and the small rectilinear shape.

FIG. 25 is an elevation of a concept using the module units in combination of the tabs, the large rectilinear shape and the cascades.

FIG. 26 is an elevation of a concept using the module units in combination of the tabs, the scalloped shape and the cascades.

FIG. 27 is an elevation of a concept using the module units in combination of the tabs, the triangular shape and the cascades.

FIG. 28 is an elevation of a concept using the module units in combination of the tabs, the triangular shape and the cascades.

FIG. 29 is an elevation of a concept using the module units in combination of the tabs, the scalloped shape and the cascades.

FIG. 30 is an elevation of a concept using the module units in combination of the tabs, the large rectilinear shape, the jabots and the cascades.

FIG. 31 is an elevation of a concept using the module units in combination of the tabs, the scalloped shape, the jabots and the cascades.

FIG. 32 is an elevation of a concept using the module units in combination of the tabs, the triangular shape, the jabots and the cascades.

FIG. 33 is an elevation of a concept using the module units in combination of the tabs, the large rectilinear shape, the small rectilinear shape and the cascades.

FIG. 34 is an elevation of a concept using the module units in combination of the tabs and the large rectilinear shape, button backs, and cascades.

FIG. 35 is an elevation of a concept using the module units in combination of the tabs and the large rectilinear shape, button backs, and cascades.

FIG. 36 is an elevation of a concept using the module units in combination of the tabs, the large rectilinear shape and the button backs.

FIG. 37 is an elevation of a concept using the module units in combination of the tabs, the large rectilinear shape and the button backs.

FIG. 38 is an elevation of a concept using the module units in combination of the tabs, the triangular shape and the tassel tacks.

FIG. 39 is an elevation of a concept using the module units in combination of the tabs, the triangular shape and the tassel tacks.

FIG. 40 is an elevation of a concept using the module units in combination of the tabs, the triangular shape, the cascades and the tassel tacks.

FIG. 41 is an elevation of a concept using the module units in combination of the tabs, the triangular shape, the jabots, the cascades and the tassel tacks.

FIG. 42 is an elevation of a concept using the module units in combination of the tabs, the triangular shape, the cascades and the tassel tacks.

FIG. 43 is an elevation of a concept using the module units in combination of the tabs, the triangular shape and the tassel tacks.

FIG. 44 is an elevation of a concept using the module units in combination of the tabs, the triangular shape, the large rectilinear shape and the tassel tacks.

FIG. 45 is an elevation of a concept using the module units in combination of the tabs, the triangular shape, the jabots and the tassel tacks.

FIGS. 46a-46d are examples of tables that can be used in the system of the invention to select the style and quantity of the modules and tabs based on a selected width of an area to be treated.

FIG. 47 is an example of directions for selecting the style and quantity of modules and couplers using the system of the invention.

### PREFERRED EMBODIMENTS

In one embodiment, the invention is directed to a modular system for creating a horizontally arranged treatment for an area comprising a plurality of interchangeable prefabricated components and an optional plurality of couplers, wherein the interchangeable prefabricated components comprise various materials, styles and sizes; a direction component, which includes choosing a quantity of interchangeable prefabricated components and optionally choosing a quantity of couplers, to create horizontally arranged combinations having various selected widths that is selected by the end user.

Such a modular system can also comprise a second direction component, which includes directions to optionally couple the coupler to the interchangeable prefabricated component and installing the chosen interchangeable prefabricated components and optional couplers to create the treatment.

In a preferred embodiment, the modular system is for creating a window treatment, more preferably a valance comprising a plurality of interchangeable prefabricated fabric components defining two buttonholes each positioned in an upper corner thereof; a plurality of tabs, each of the tabs defining a buttonhole on one end and a button on the other end; and a direction component, the direction component includes choosing a quantity of modules based on a selected width and choosing a quantity of tabs, the direction component further including overlapped edge-to-edge fastening of at least two interchangeable prefabricated fabric components to each other with the tabs, horizontally arranging the fastened interchangeable prefabricated fabric components, and installing the horizontal arrangement over a window.

In another preferred embodiment the second direction component further includes directions to overlap at least two of the interchangeable prefabricated modules and to couple the interchangeable prefabricated components to each other with the at least one coupler and horizontally arranging the interchangeable prefabricated components to form a layered treatment.

The invention also provides for a method for creating a treatment., such as a valance, for an area, such as a window, comprising selecting at least one interchangeable prefabricated component from a plurality of interchangeable prefabricated components based on a selected width of an area to be treated by a horizontal arrangement of the at least one interchangeable prefabricated component; optionally selecting at least one coupler from a plurality of couplers; arranging the selected at least one interchangeable prefabricated component and the optional coupler to form the horizontal arrangement; and installing the horizontal arrangement of the at least one interchangeable prefabricated component on an area to form the treatment.

In another embodiment of the invention, the invention is directed to selecting a prefabricated component from depictions, such as those in a computer database or from a display, for example, at a store. The depictions represent actual prefabricated (i.e., finished) components and are not intended to represent options for a custom treatment in which the components thereof are not prefabricated. Thus, the invention also includes a modular system for creating a horizontally arranged treatment for an area comprising a plurality of depictions of interchangeable finished components and an optional plurality of depictions of couplers, wherein the depictions of the interchangeable finished components comprise various depictions of materials, styles and sizes; a direction component, the direction component includes choosing a quantity of interchangeable finished components and optionally choosing a quantity of couplers, to create horizontally arranged combinations having various selected widths.

A modular system based on depictions as described is useful for selecting a treatment, for example, over a communications network. Thus, the present invention also includes a method for selecting a treatment for an area over a communications network, such as an internet, comprising accessing the communications network from a terminal; selecting at least one depiction of an interchangeable finished component stored in a database connected to the communications network including a plurality of depictions of interchangeable finished components, wherein the selecting step is based on a selected width of an area to be treated by a horizontally arranged combination of the interchangeable finished components; wherein the depictions of the interchangeable finished components comprise depictions of various materials, styles and sizes; and optionally selecting at least one depiction of a coupler from a plurality of depictions of the couplers.

In another embodiment, the invention is directed to a computer program. Thus, the invention is directed to a recordable medium having a program stored thereon comprising a computer program that performs the function of: selecting at least one depiction of an interchangeable finished component stored in a database connected to the communications network including a plurality of depictions of interchangeable finished components based on a selected width of an area to be treated by a horizontally arranged combination of the finished components; wherein the depictions of the interchangeable finished components comprise depictions of various materials, styles and sizes; and selecting at least one depiction of a coupler from a plurality of depictions of the couplers.

In another embodiment, the invention is directed to a kit for creating a treatment for an area to be treated comprising at least one interchangeable finished component selected from a plurality of interchangeable finished components, wherein the at least one interchangeable finished component is selected to conform to a selected width; at least one coupler capable of being coupled to the at least one interchangeable finished component; and directions for creating at least one horizontal arrangement from the at least one finished component and at least one coupler.

In a preferred embodiment, the modular system is for creating a window treatment, comprising a plurality of interchangeable prefabricated fabric components defining two buttonholes each positioned in an upper corner thereof; a plurality of tabs, each of the tabs defining a buttonhole on one end and a button on the other end; and a direction component, the direction component includes choosing a quantity of modules based on a selected width and choosing a quantity of tabs, the direction component further including overlapped edge-to-edge fastening of at least two interchangeable prefabricated fabric components to each other with the tabs, horizontally arranging the fastened interchangeable prefabricated fabric components, and installing the horizontal arrangement over a window.

The modules can be made of any flexible or inflexible material that can form a treatment. Preferably the modules are made of fabric of either one or two-ply that can be easily coupled to each other and can be coupled to a coupler such as a fastener. In one preferable embodiment, the modules are constructed of two-ply fabric. The modules are interchangeable and when two-ply modules are selected, the modules can also be reversible. For the purposes of this application, the modules are defined as finished, prefabricated components of the final treatment. It is a critical component of this invention that the modules are prefabricated components or depictions that represent prefabricated components. Pre-fabricated components are completely manufactured segments that are ready for assembly by the end user without the need for further manufacture or sewing.

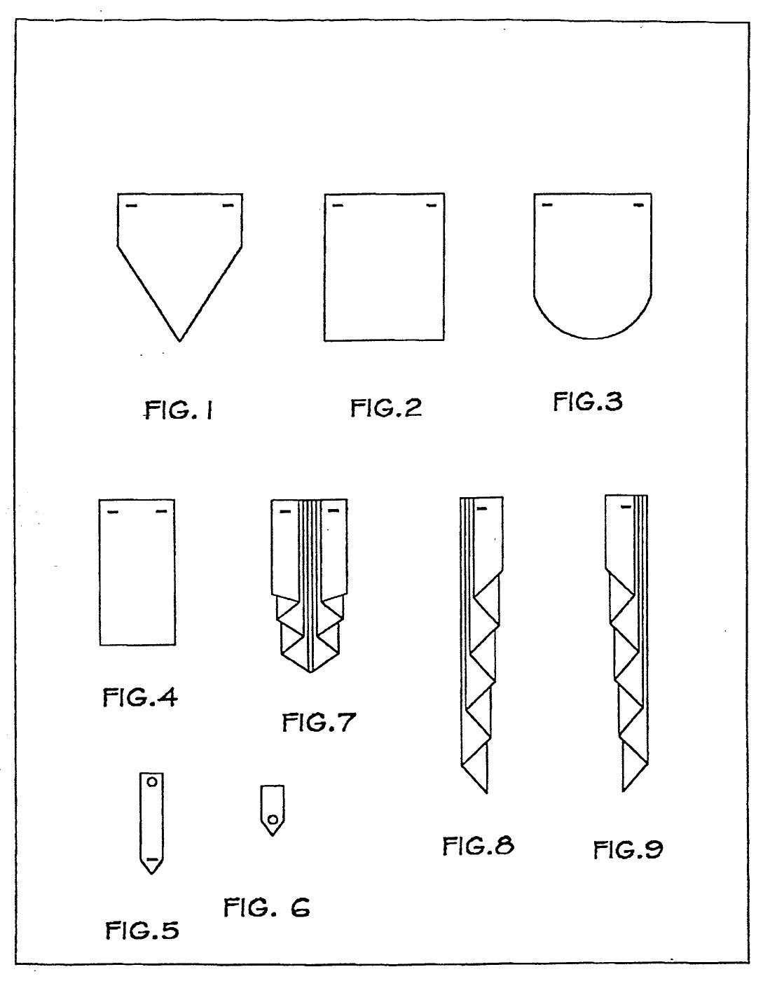

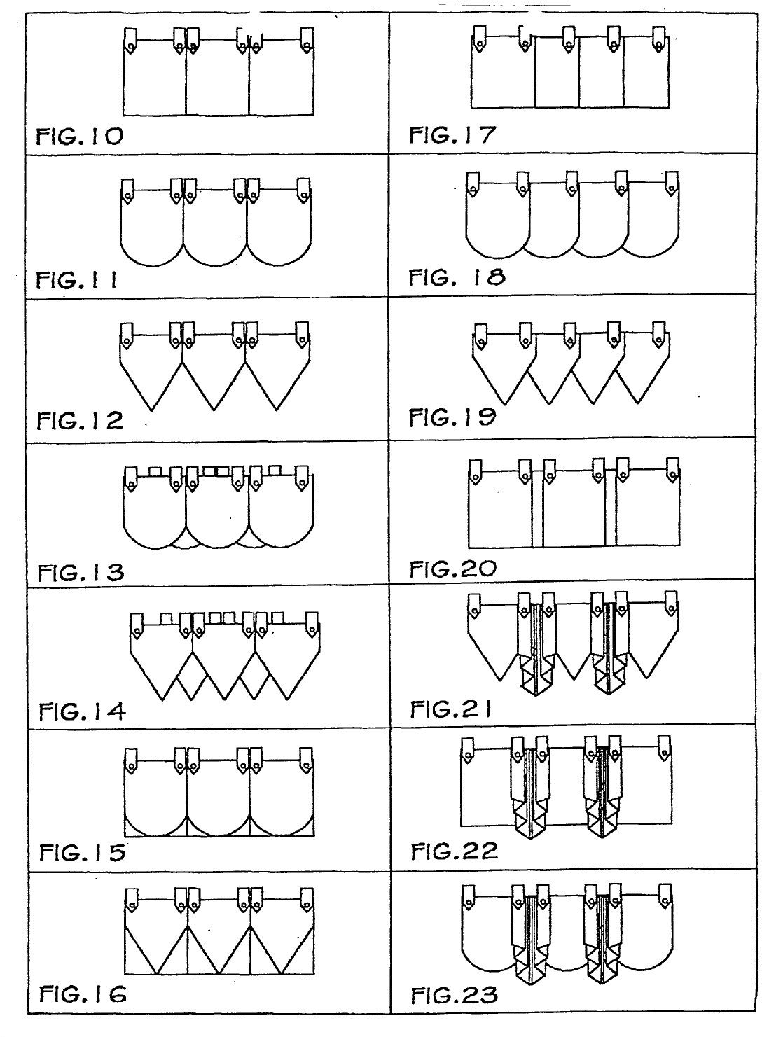

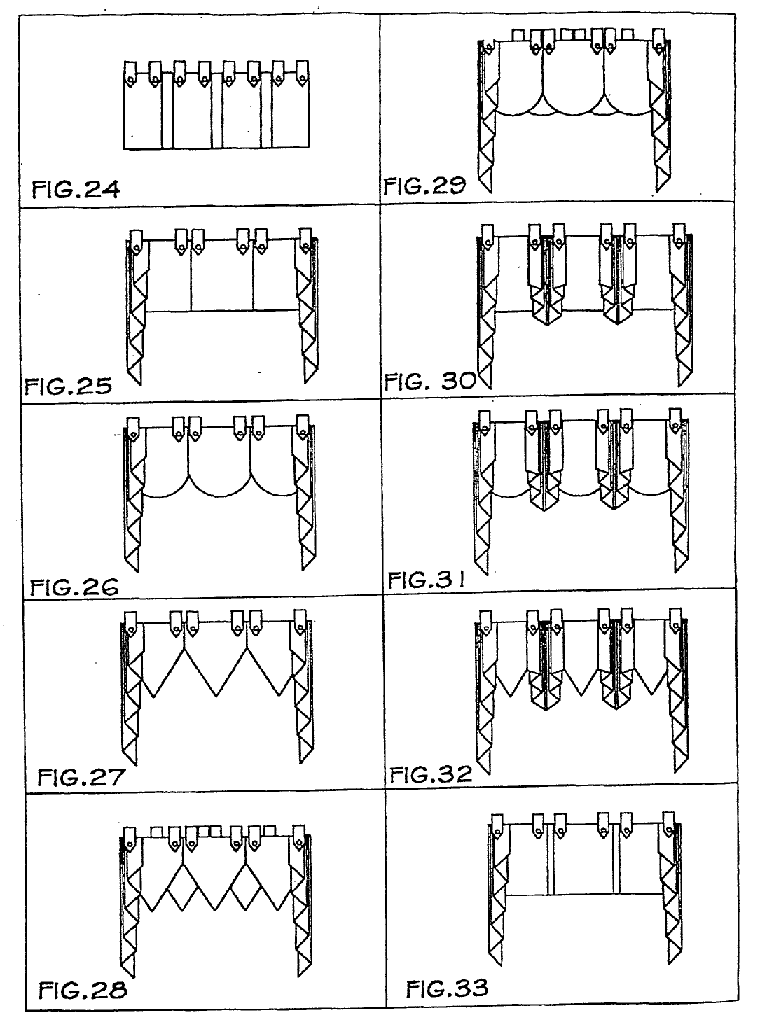

The modules comprise any suitable shape, size or style. In a preferred embodiment, the modular fabric units are triangular, rectilinear, and rounded sewn shape manufactured of two-ply fabric. Non-limiting examples of shapes in accordance with the invention are the pennant (FIG. 1), tailored (FIG. 2), scalloped (FIG. 3), box pleat (FIG. 4), jabot (FIG. 7), or the left or right cascade (FIGS. 8 and 9) shapes.

The modules can be of any width or length that is suitable for the invention. Preferably, the length of the modules are from 3-100 inches depending on the size of the window and more preferably 10-24 inches. Most preferably, the length of the module is sufficient to form a valance or window top treatment. The width of the modules are preferably from 2-24 inches, and more preferably 4-15 inches. Preferably, the cascade is about 3-12 inches wide, more preferably about 4-6 inches, and most preferably about 5 inches. The jabot is about 5-20 inches wide, more preferably about 7-9 inches wide, and most preferably about 8 inches wide. The rectilinear, triangular and rounded modules are preferably about 1-30 inches wide, more preferably 5-20 inches wide, even more preferably 7-9 or 13-15 inches wide, and most preferably about 8 or about 14 inches wide.

The modules of the present invention are mounted on a decorative rod or other holder and preferably mounted along a top edge of a window or other area to be treated. The modular units are coupled to the rod with independent couplers, for example, tabs. Installation of the modules can be accomplished using directions that include coupling the coupler to the interchangeable prefabricated component and/or coupling the components to each other.

Couplers are devices that are coupled to one or more modules at a time. Preferably, the treatment includes at least two modules. When couplers are coupled to two or more modules, a layered treatment is possible. Preferably, the couplers themselves can be further coupled to a rod or other holder. Examples of couplers which are not limited to the following, include one or more of a tab, fastener, snap, ring, hook, button and button hole, or a sleeve having at least one button or fastener for mounting modules, closure device, or velcro, or equivalents thereof. Preferably, the tabs are comprised of two plies of fabric with a button sewn on one end and a buttonhole on the other end.

In a more preferred embodiment, the module contains at least one buttonhole or equivalent thereof. Preferably, each module has 1-4 buttonholes, more preferably 1-2 buttonholes. Even more preferably, a module has two buttonholes placed in the top two corners of the module. Then, tabs are joined to the modules by placing the tab's button through the module's buttonhole and looping the tab over a rod, for example, and closing it using a buttonhole on the opposite end of the tab to close the loop. In a more preferred embodiment, the modules overlap each other so that the first module's buttonhole overlaps a second module's buttonhole and the tab's button is inserted through both modules' buttonholes and through the buttonhole of the tab to form a layered effect. In a preferred embodiment of the invention having a layered combination as shown, for example, in FIGS. 17-24, a threaded shank on the button allows room for multiple fabric layers.

In another preferred embodiment, prefabricated jabot and cascade components are created using two plies of fabric with the bottom edge cut and sewn on an angle and then pressed and layered into folds that are tacked together. Preferably, the cascades have one buttonhole while the jabot has two. The cascades are produced with folds for a left and a right cascade. By combining or layering the modular units and/or the cascade or jabots, a variety of designs can be achieved, as shown in the FIGS. 10-45.

A distinct advantage of the modular system is the ability to attach multiple and varied modules using the independent tabs in a single treatment scheme which allow for maximum flexibility of the finished style and/or color palette.

Accessories also offer further decorative options. In a preferred embodiment, button covers can be placed over the buttons on the tabs to offer additional color placement. Preferably button covers are made using a metal housing with a covered fabric button adhered to the metal housing that will clasp over the button on the tab.

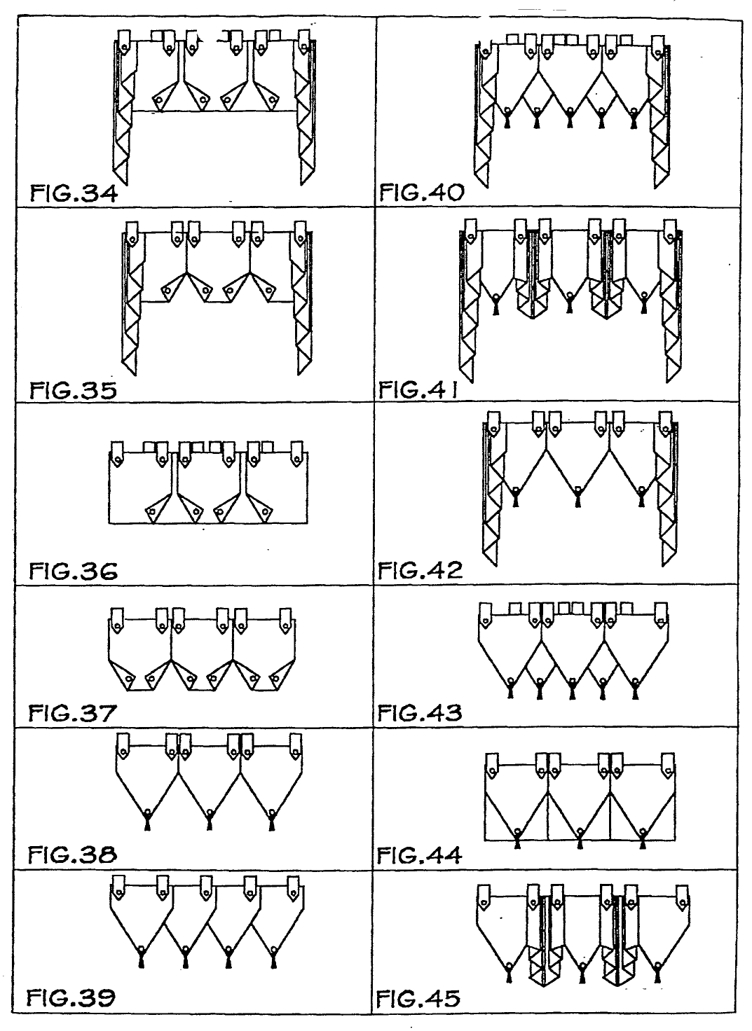

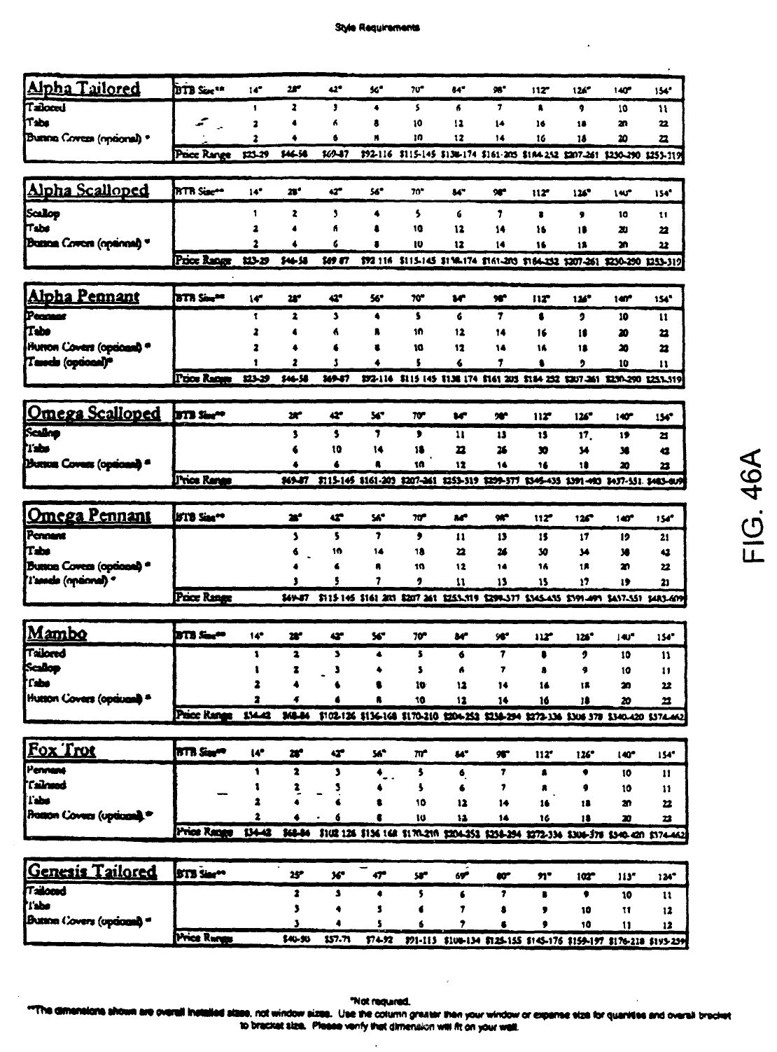

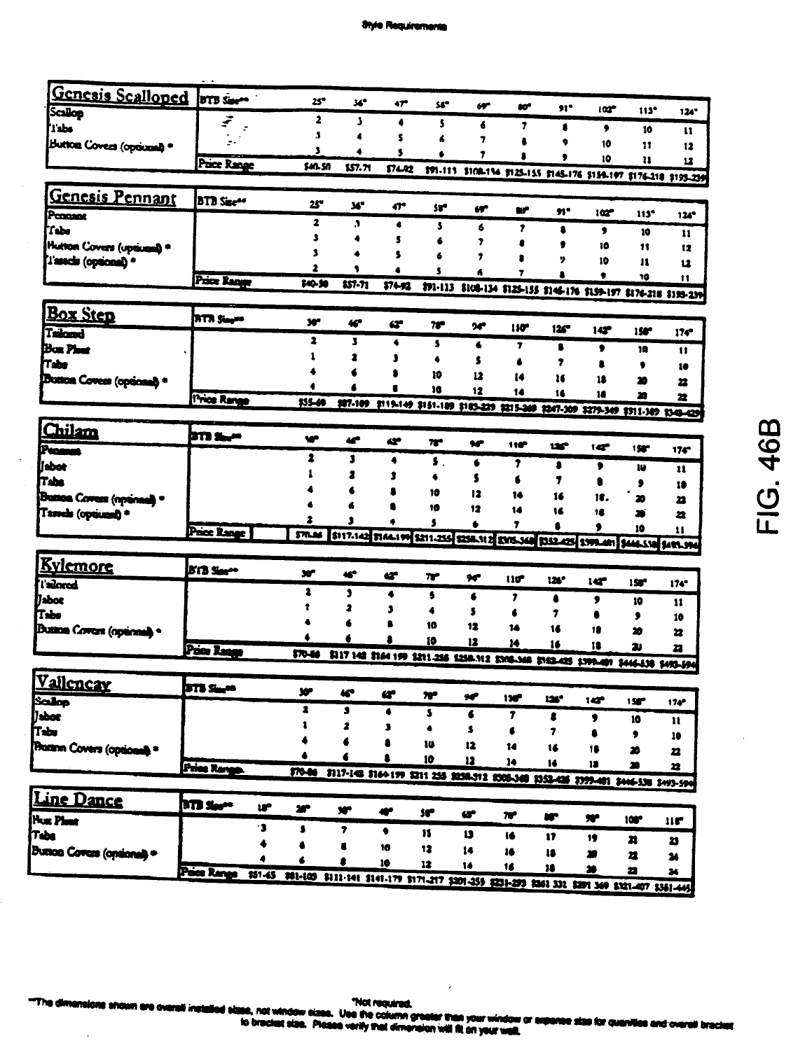

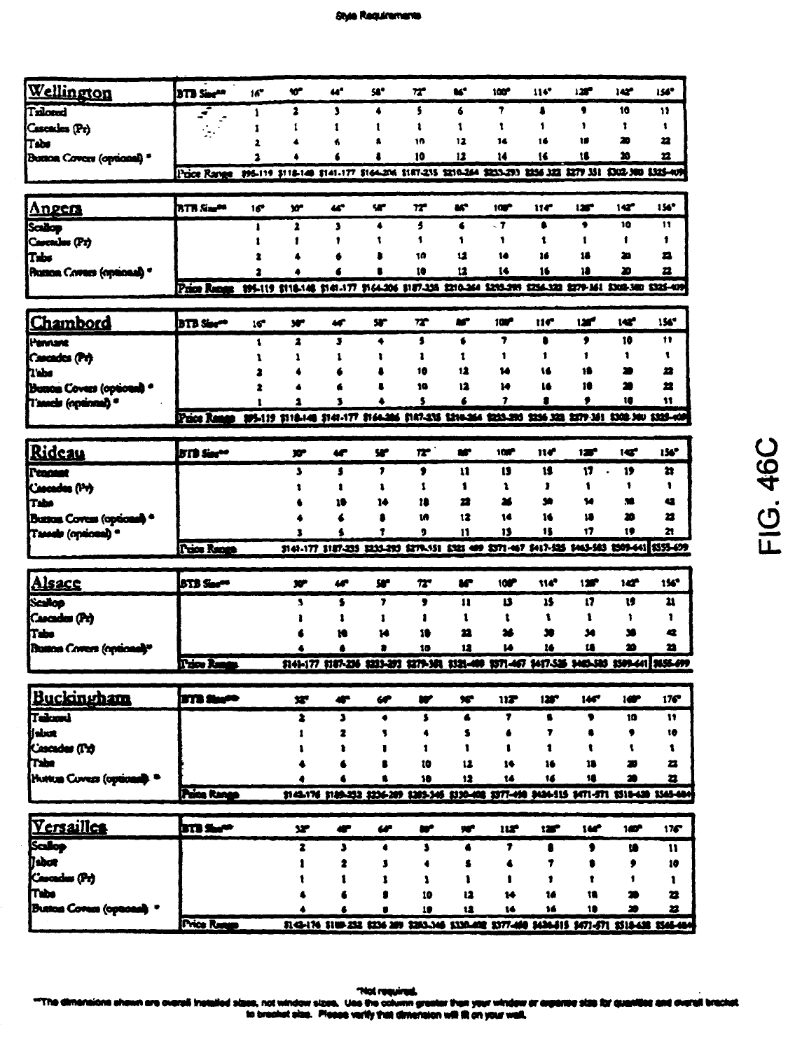

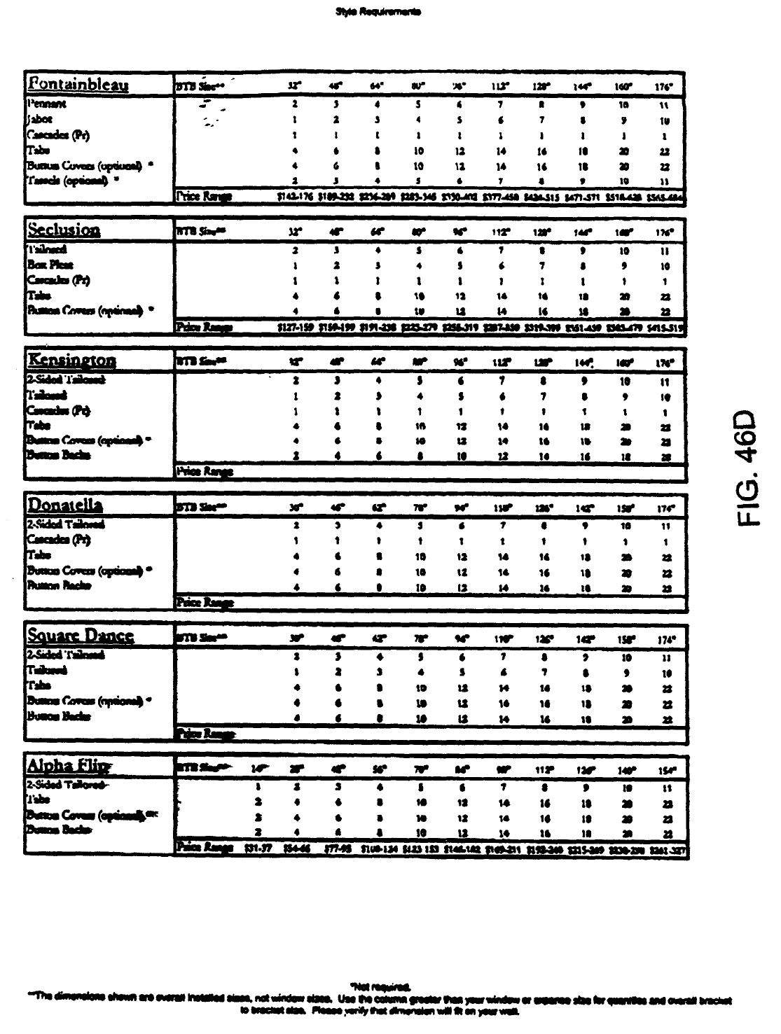

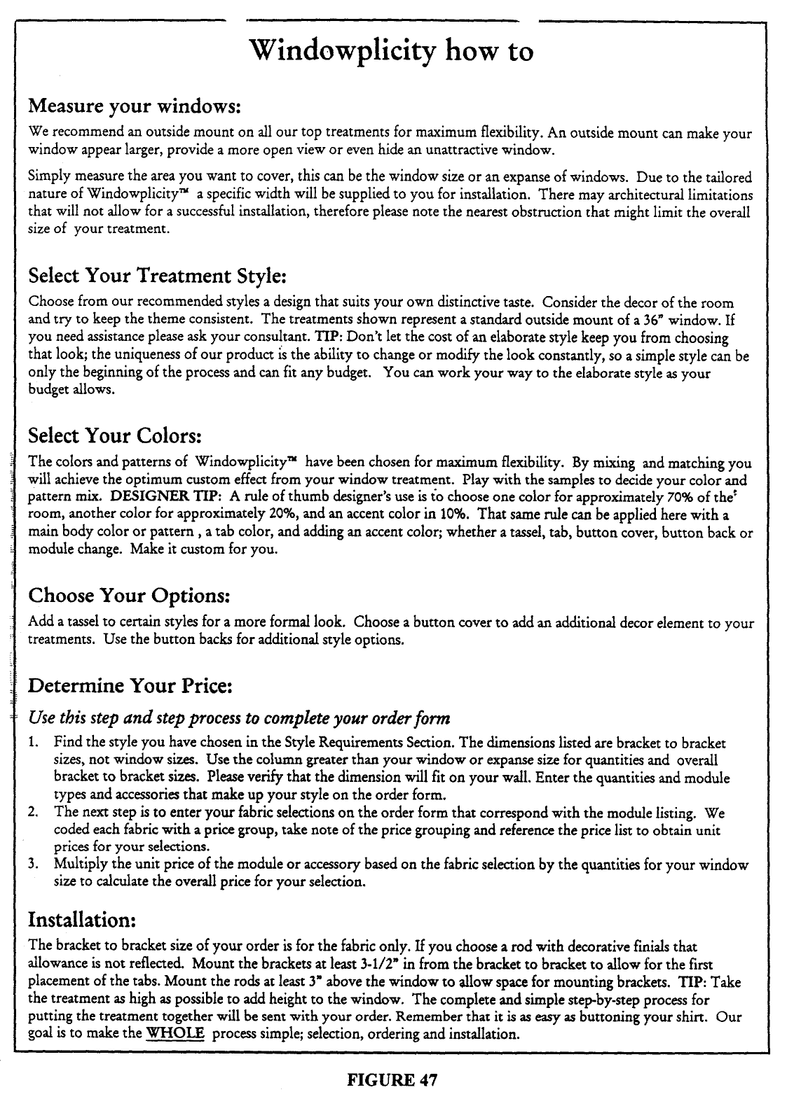

In a further embodiment, button backs can be used to create a layered effect on the rectilinear shaped units, for example. Flaps can be turned back on the modules and the button backs are pushed through the flap and tacked in placed to hold the flap up. Preferably, the button backs are made of a covered button with lapel pin hardware adhered to the button. Button backs can be removed or applied as desired. Examples of combinations using button backs is shown in FIGS. 34-37.

Decorative accessories can be attached to the modules to provide further decorative effects. For example, tassels can be placed on the triangular shaped modules to offer a further decorative option. Combinations resulting from the system of the invention using tassels are shown in FIGS. 40-45. The tassels are preferably removably applied to the modules with the label pin hardware as mentioned above and can be removed or applied as desired.

The system of the invention also allows for the selection of modules and couplers to be selected over a communications network. Any suitable communications network comprising, but not limited to an internet, such as the Internet, an intranet, LAN, or WAN are preferred. Preferably, the communications network is the Internet having a web site that employs software having an interactive design and ordering configuration to use the system of the invention. Preferably, the selection of components is based on the availability of prefabricated components. Thus, the components are not custom made to order but rather the end user selects depictions of components that are prefabricated.

Once a consumer has selected the modules and the couplers for a selected width of an area to be treated, the layout of the design can be completed and the couplers can be added. The modules and couplers are arranged and then installed onto a rod or holder of choice and mounted over the window, or other area to be treated.

Further variations and modifications of the foregoing will be apparent to those skilled in the art and are intended to be encompassed by the claims appended hereto.

What is claimed is:

1. A modular system for creating a horizontally arranged treatment for an area comprising
a plurality of interchangeable prefabricated components and an optional plurality of couplers, wherein said interchangeable prefabricated components comprise various materials, styles and sizes;
a direction component, said direction component includes choosing a quantity of interchangeable prefabricated components and optionally choosing a quantity of couplers, to create horizontally arranged combinations having various selected widths.

2. The modular system defined in claim 1, further comprising
a plurality of couplers;
wherein said direction component further includes choosing a quantity of said couplers.

3. The modular system defined in claim 1
wherein said materials are fabrics, and
wherein said treatment is a window treatment.

4. The modular system defined in claim 2
wherein said couplers are fasteners, tabs, buttons and buttonholes, snaps, hooks, sleeves, and/or velcro.

5. The modular system defined in claim 1 further comprising
a second direction component, said second direction component includes optionally coupling said coupler to said interchangeable prefabricated component and installing said chosen interchangeable prefabricated components and optional couplers to create said treatment.

6. The modular system defined in claim 5
wherein said second direction component further includes directions for overlapping at least two of said interchangeable prefabricated modules and coupling said interchangeable prefabricated components to each other with said at least one coupler and horizontally arranging said interchangeable prefabricated components to form a layered treatment.

7. A method for creating a treatment for an area comprising
selecting at least one interchangeable prefabricated component from a plurality of interchangeable prefabricated components based on a selected width of an area to be treated by a horizontal arrangement of said at least one interchangeable prefabricated component;
optionally selecting at least one coupler from a plurality of couplers;
arranging said selected at least one interchangeable prefabricated component and said optional coupler to form said horizontal arrangement; and
installing said horizontal arrangement of said at least one interchangeable prefabricated component on an area to form said treatment.

8. The method defined in claim 7
wherein said installing step includes installing said horizontal arrangement over a window to form a window treatment.

9. A modular system for creating a horizontally arranged treatment for an area comprising
a plurality of depictions of interchangeable finished components and an optional plurality of depictions of couplers, wherein said depictions of said interchangeable finished components comprise various depictions of materials, styles and sizes;
a direction component, said direction component includes choosing a quantity of interchangeable finished components and optionally choosing a quantity of couplers, to create horizontally arranged combinations having various selected widths.

10. A method for selecting a treatment for an area over a communications network comprising
accessing said communications network from a terminal;
selecting at least one depiction of an interchangeable finished component stored in a database connected to said communications network including a plurality of depictions of interchangeable finished components, wherein said selecting step is based on a selected width of an area to be treated by a horizontally arranged combination of said interchangeable finished components;
wherein said depictions of said interchangeable finished components comprise depictions of various materials, styles and sizes;
wherein said depictions represent prefabricated components; and
optionally selecting at least one depiction of a coupler from a plurality of depictions of said couplers.

11. The method defined in claim 10 wherein the communications network is an internet.

12. A recordable medium having a program stored thereon comprising a
computer program that performs the function of:
selecting at least one depiction of an interchangeable finished component stored in a database connected to said communications network including a plurality of depictions of interchangeable finished components based on a selected width of an area to be treated by a horizontally arranged combination of said finished components;
wherein said depictions of said interchangeable finished components comprise depictions of various materials, styles and sizes; and
selecting at least one depiction of a coupler from a plurality of depictions of said couplers.

13. A kit for creating a treatment for an area to be treated comprising
at least one interchangeable finished component selected from a plurality of interchangeable finished components, wherein said at least one interchangeable finished component is selected to conform to a selected width;
at least one coupler capable of being coupled to said at least one interchangeable finished component; and
directions for creating at least one horizontal arrangement from said at least one finished component and at least one coupler.

14. The kit defined in claim 13
wherein at least two finished components are selected.

15. A modular system for creating a valance window treatment comprising
a plurality of interchangeable prefabricated fabric components defining two buttonholes each positioned in an upper corner thereof;
a plurality of tabs, each of said tabs defining a buttonhole on one end and a button on the other end; and
a direction component, said direction component includes choosing a quantity of modules based on a selected width and choosing a quantity of tabs,
said direction component further including overlapped edge-to-edge fastening of at least two interchangeable prefabricated fabric components to each other with said tabs, horizontally arranging said fastened interchangeable prefabricated fabric components, and installing said horizontal arrangement over a window.
